(19) United States
(12) Patent Application Publication
(10) Pub. No.: US 2024/0227537 A1
(43) Pub. Date: Jul. 11, 2024

(54) VEHICLE

(71) Applicant: TOYOTA JIDOSHA KABUSHIKI KAISHA, Toyota-shi (JP)

(72) Inventors: Hiroki TSUNOGAWA, Susono-shi (JP); Kazumasa Shimode, Susono-shi (JP); Masahide Uemura, Susono-shi (JP)

(73) Assignee: TOYOTA JIDOSHA KABUSHIKI KAISHA, Toyota-shi (JP)

(21) Appl. No.: 18/493,249

(22) Filed: Oct. 24, 2023

(30) Foreign Application Priority Data
Jan. 11, 2023 (JP) 2023-002576

(51) Int. Cl. B60K 7/00; B60G 7/00; B60G 7/02; B60K 17/04

(52) U.S. Cl. CPC B60K 7/0007; B60G 7/008; B60G 7/02; B60K 17/043; B60K 2007/0061

(57) ABSTRACT

The vehicle includes a vehicle body, a wheel that support the vehicle body, an in-wheel type motor unit that drives the wheel, and a trailing arm that is connected to the motor unit via an elastic member and extends toward the front of the vehicle. An angle formed by a first straight line connecting the wheel rotation center corresponding to the rotation axis of the wheel, the first connection point which is a connection point between the motor unit and the trailing arm, and a second straight line connecting the first connection point, the second connection point which is a connection point between the trailing arm and the vehicle body, is set to 150 degrees or more and 210 degrees or less.

### CROSS-REFERENCE TO RELATED APPLICATION

This application claims priority to Japanese Patent Application No. 2023-002576 filed on Jan. 11, 2023, incorporated herein by reference in its entirety.

BACKGROUND

### 1. Technical Field

The technology disclosed in the present specification relates to a vehicle.

### 2. Description of Related Art

One form of a vehicle including a motor is an in-wheel motor. An in-wheel motor is a motor integrated into a hub. As such an in-wheel type motor, an in-wheel motor unit is disclosed, in which a trailing arm that is connected to the motor extends in a forward direction in the vehicle, and that is connected to a vehicle body through a bushing (Japanese

Unexamined Patent Application Publication No. 2020-172188 (JP 2020-172188 A)).

Description is made therein that in this structure, vibration of the motor is received by the bushing at the distal end of the trailing arm by bringing an angle made between a straight line connecting a linking point of the distal end of the trailing arm and the vehicle body and a linking point of the trailing arm and the motor, and a straight line connecting a motor center point and the linking point of the trailing arm and the motor, from 135 degrees to be close to 90 degrees.

### SUMMARY

In a vehicle including an in-wheel motor unit, when a tire rides over an uneven spot (bump) on a road surface, torque that rotates the unit may be generated by reactive torque from the tire. It has been found that, depending on the motor center point and the angle of the trailing arm, the generated torque may be conveyed to the vehicle body as a large force.

The present disclosure provides technology capable of suppressing input from a road surface from being conveyed to a vehicle body in a vehicle including an in-wheel motor.

The technique disclosed in the present specification is embodied as a vehicle.

A vehicle includes a vehicle body, a wheel supporting the vehicle body, a motor unit including an in-wheel motor that drives the wheel, and a trailing arm linked to the motor unit through an elastic member and extending toward a vehicle front.
An angle made by a first straight line connecting a wheel center that matches a rotation axis of the wheel and a first linking point that is a linking point of the motor unit and the trailing arm, and a second straight line connecting the first linking point and a second linking point that is a linking point of the trailing arm and the vehicle body, is no less than 150 degrees and no more than 210 degrees.

Thus, reactive torque based on unevenness of the road surface or the like can be suppressed from being conveyed to the vehicle body. That is to say, the elastic member is deformed and absorbs or cushions the reactive torque acting on the wheels due to the uneven road surface or the like, so as to be suppressed from being conveyed to the trailing arm. Further, up-down direction vibrations of the trailing arm caused in accordance with deformation of the elastic member are suppressed from being conveyed to the vehicle body, by setting the angle within the above range. As a result, input from the road surface is suppressed from being conveyed to the vehicle body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a main part of a vehicle according to an embodiment;

FIG. 2 is a diagram schematically showing a configuration of the motor unit shown in FIG. 1;

FIG. 3 is a view showing a connection structure of the trailing arm shown in FIG. 1;

FIG. 4A is a diagram illustrating an operation of a vehicle according to an embodiment; and

FIG. 4B is a diagram illustrating an operation of a vehicle having an angle θ of less than 150 degrees.

### DETAILED DESCRIPTION OF EMBODIMENTS

The vehicle disclosed herein relates to a vehicle. The vehicle includes a vehicle body, a wheel that supports the vehicle body, and a trailing arm that is connected to the motor unit via an elastic member and extends toward the front of the vehicle and includes a motor unit including an in-wheel type motor that drives the wheel, and a first straight line that connects a wheel rotation center corresponding to a rotation axis of the wheel, a first connection point that is a connection point between the motor unit and the trailing arm, and a second straight line that connects the first connection point and a second connection point that is a connection point between the trailing arm and the vehicle body can have an angle θ of 150 degrees or more and 210 degrees or less.

In an embodiment of the present disclosure, the angle θ maybe greater than or equal to 160 degrees and less than or equal to 200 degrees, or greater than or equal to 170 degrees and less than or equal to 190 degrees. By being close to 180 degrees, the transmission of the input from the road surface to the vehicle body is further suppressed.

In an embodiment of the present disclosure, the motor unit may further include a speed reduction mechanism. When the speed reduction mechanism is provided, the rotational torque is more likely to act on the motor unit, and thus the coupling structure of the motor unit and the trailing arm in the vehicle of the present disclosure is meaningful.

In an embodiment of the present disclosure, the trailing arm may be connected to the vehicle body via an elastic member. In this way, the transmission of the input to the vehicle body from the road surface is further reduced.

The elastic member may be a bushing made of one or more elastomeric materials. In this way, the reaction torque can be easily reduced.

Hereinafter, a vehicle disclosed in the present specification will be described with reference to the drawings as appropriate. Note that the vehicle illustrated in the drawings is only one embodiment of the vehicle disclosed in the present specification.

In the present specification, the descriptions such as the front, rear, and front-rear directions mean the front, rear, and front-rear directions of the vehicle, respectively. Similarly, the descriptions of the left direction, the right direction, and the width direction mean the left direction, the right direction, and the vehicle width direction in the vehicle. The descriptions such as an upward direction, a downward direction, and a height direction refer to an upward direction, a downward direction, and a height direction of the vehicle. The direction FR in the drawing indicates the front of the vehicle, and the direction RR indicates the rear of the vehicle. Similarly, the direction LH indicates the left of the vehicle, the direction RH indicates the right of the vehicle, the direction UP indicates the vehicle upper, and the direction DW indicates the vehicle lower.

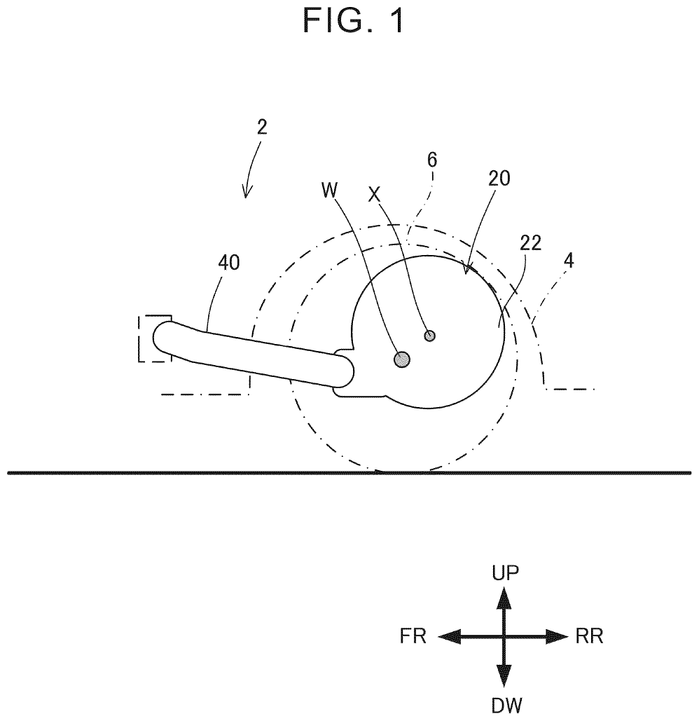

FIG. 1 shows an outline of the vicinity of an in-wheel motor type motor unit 20 of a vehicle 2. The vehicle 2 is an electrified vehicle that travel with the power of a motor. The vehicle 2 includes a vehicle body 4, a wheel (hereinafter, also referred to as tire) 6, and a motor unit 20. The wheel shown in FIG. 1 is a rear wheel and supports a vehicle body 4. In addition, the vehicle 2 includes a suspension system and the like generally included in the vehicle 2, and a description thereof will be omitted herein.

The wheel 6 supports the vehicle body 4. In the example shown in FIG. 1, the wheel 6 is a tire located at the rear of the vehicle 2. The wheel 6 rotates about a wheel rotation axis W extending along the vehicle width direction. The motor unit 20 is directly connected to the wheel 6 without a suspension.

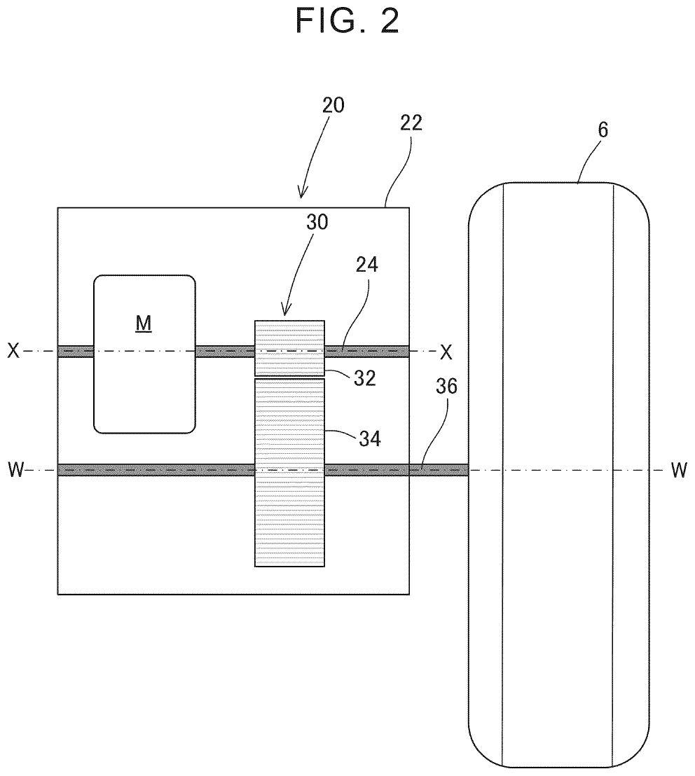

The motor unit 20 is also referred to as a so-called in-wheel motor or a wheel hub motor. FIG. 2 schematically illustrates the motor unit 20. As shown in FIG. 2, the motor unit 20 is disposed inside the wheel 6 in the width direction. The motor unit 20 transmits the rotational force of the motor M to the wheel 6 to rotate.

As shown in FIG. 2, the motor unit 20 houses the motor M and the speed reduction mechanism 30 in the housing 22. The motor M is rotated by electric power from a battery or the like included in the vehicle 2. The motor M transmits the rotation to the speed reduction mechanism 30 through the shaft body 24 fixed in the housing 22 via a bearing (not shown). The shaft body 24 has an axial center coinciding with the motor rotation axis X.

The speed reduction mechanism 30 includes a drive gear 32, a driven gear 34, and a shaft body 36. The speed reduction mechanism 30 reduces the rotational force of the motor M and transmits the reduced rotational force to the wheel 6. The drive gear 32 is connected to the shaft body 24 rotated by the motor M, and rotates with the rotation of the motor M. The driven gear 34 meshes with the drive gear 32 and rotates in the opposite direction as the drive gear 32 rotates. The driven gear 34 is fixed to a shaft body 36 fixed to the housing 22 via a bearing (not shown). A wheel 6 is fixed to the shaft body 36. Accordingly, as the driven gear 34 rotates, the wheel 6 rotates together with the shaft body 36. Since the driven gear 34 has a larger diameter than the drive gear 32, the rotational force of the motor M is reduced and transmitted to the wheel 6. The shaft body 36 has an axial center coinciding with the wheel rotation axis W. The wheel rotation axis W is also the center of rotation of the wheel disclosed herein.

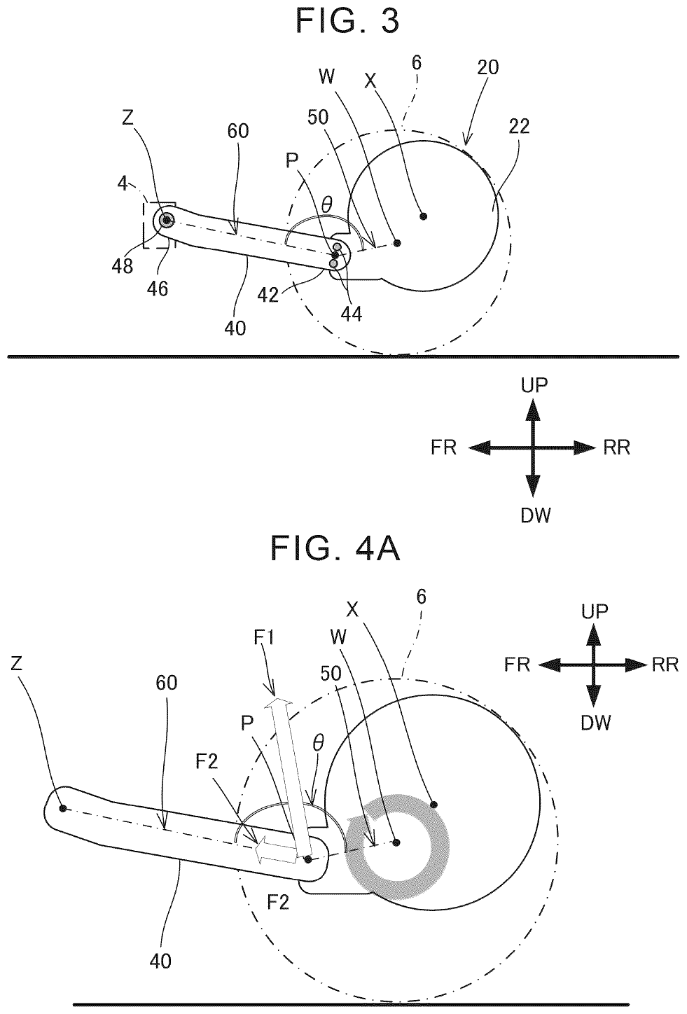

As shown in FIG. 3, the vehicle 2 includes a trailing arm 40 on the front side of the motor unit 20. The trailing arm 40 is an elongated member extending from the motor unit 20 toward the front side. The trailing arm 40 is not particularly limited, but is, for example, a rod-shaped or plate-shaped member.

The rear end portion 42 of the trailing arm 40 is connected to the housing 22 of the motor unit 20 via two bushings 44 of elastomeric material. The bushing 44 is an example of an elastic member in the present specification.

Specifically, the bushing 44 is inserted into and fixed to the rear end portion 42 of the trailing arm 40 and/or the connection through-hole formed in the housing 22, and then fastened and fixed by bolts or the like. As a result, the bushing 44 can absorb at least a part of the rotational torque action generated in the motor unit 20 and buffer it.

The elastomer material is not particularly limited, but may be appropriately selected from known materials such as a synthetic resin material having rubber elasticity or a resin-elastomer composite material in addition to natural rubber.

The forward front end portion 46 of the trailing arm 40 is also connected to a portion of the vehicle body 4 via one bushing 48 of elastomeric material. Similar to the rear end portion 42, the bushing 48 is inserted and fixed into a through hole for connection formed in the front end portion 46 of the trailing arm 40 and/or the vehicle body 4, and then fastened and fixed by a bolt or the like. As a result, the bushing 48 can absorb and cushion at least a part of the vibration generated in the trailing arm 40. The bushing 48 is an example of an elastic member in the present specification.

Although not shown, the motor unit 20 is connected to the vehicle body 4 via a suspension, an upper arm, a front lower arm, a rear lower arm, a shock absorber, and the like in addition to the trailing arm 40. For example, the upper arm extends from the upper rear portion of the motor unit 20 toward the inside of the vehicle 2, the lower front arm extends from the lower front portion of the motor unit 20 toward the inside of the vehicle 2, and the lower rear arm extends from the motor unit 20 toward the inside of the vehicle 2 and is connected to the vehicle body 4.

Next, a connection structure of the trailing arm 40 to the motor unit 20 will be described. As shown in FIG. 1, the connection structure of the trailing arm 40 is determined by an angle θ formed by a wheel rotation axis W of the wheel 6, a straight line 50 connecting a connection point P, which is a connection point between the motor unit 20 and the trailing arm 40 in the housing 22 of the motor unit 20, and a straight line 60 connecting the connection point P and the connecting point Z, which is a connection point between the trailing arm 40 and the vehicle body 4. The connection point P is an example of the first connection point disclosed herein, and the connection point Z is an example of the second connection point disclosed herein.

Here, the connection point P is determined by the number, the position, and the mass of the connection member at the connection portion between the trailing arm 40 and the housing 22. For example, when there is one connecting member, the position of the center of gravity of the connecting member is the connection point P. When two or more connecting members are provided, the center of gravity obtained from the positions and masses of the plurality of connecting members is the connection point P.

The connection point Z is determined by the number, the position, and the mass of the connection member at the connection portion between the trailing arm 40 and the vehicle body 4. The connection point Z is obtained in the same manner as the connection point P.

For example, the trailing arm 40 maybe provided for the vehicle 2 such that an angle θ formed by the straight line 50 and the straight line 60 is not less than 150 degrees and not more than 210 degrees. The angle θ is, for example, 160 degrees, and is, for example, 170 degrees, and is, for example, 175 degrees. The upper limit of the angle θ is, for example, 200 degrees, and for example, 190 degrees, and for example, 185 degrees. The range of the angle θ can be set by appropriately combining the upper limit and the lower limit, but is, for example, 160 degrees or more and 200 degrees or less, for example, 170 degrees or more and 190 degrees or less, and for example, 175 degrees or more and 185 degrees or less.

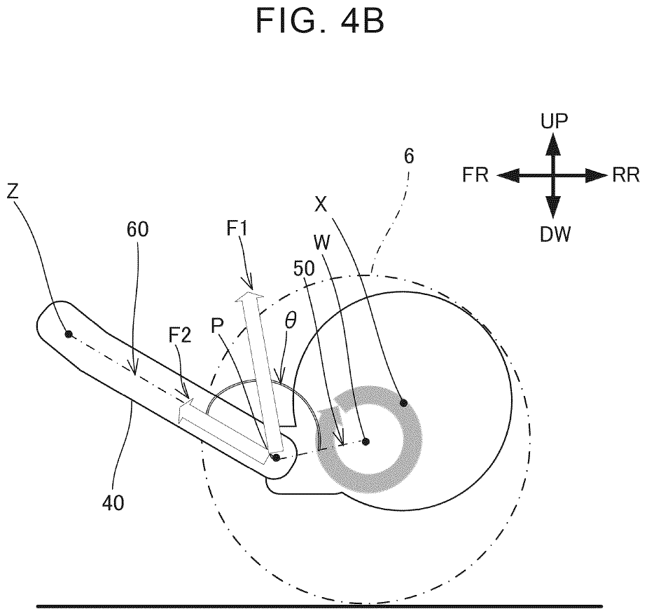

Next, referring to FIGS. 4A and 4B shown in the drawings, the action when the reaction force from the wheel 6 due to the uneven road surface in the vehicle 2 is generated will be described. As shown in FIG. 4A, when the wheel 6 of the vehicle 2 collide with unevenness of the road surface or the like, the reaction torque from the wheel is transmitted to the driven gear 34 and the drive gear 32. Since the gears 32, 34 are meshed and rotate in opposite directions, forces acting in opposite directions are transmitted to the shaft bodies 24, 36 that support the gears 32, 34. The force from the shaft bodies 24, 36 acts as a torque that rotates the speed reduction mechanism 30, i.e., the motor unit 20 to which the speed reduction mechanism 30 is fixed. As a consequence, for example, as shown in FIG. 4A, a circumferential force F1 around the wheel rotation axis W acts on the connection point P of the trailing arm 40.

Here, by providing the bushing 44 at the connection portion between the trailing arm 40 and the motor unit 20, the torque generated by the reaction torque can be absorbed and buffered by the deformation of the elastic member. The elastic deformation of the bushing 44 acts to vibrate the trailing arm 40 up and down at the connection point P. Here, as shown in FIG. 4A, since the angle θ formed by the straight line 50 and the straight line 60 is in a range of 150 degrees or more and 210 degrees or less, F2 of components of the force F1 acting on the connection point P to the trailing arm 40 along the forward direction of the trailing arm 40, that is, the direction along the straight line 60 extending toward the vehicle body 4 becomes smaller as close to 180 degrees. That is, the amount of input from the road surface to be transmitted to the vehicle body 4 can be reduced. In other words, when the angle θ is close to 180 degrees, the wheel rotation axis W, the connection point P, and the connection point Z are substantially horizontal or substantially the same height.

On the other hand, although the component along the direction perpendicular to the straight line 60 of the force F1 acting on the connection point P increases, this component is absorbed by the swing of the trailing arm 40 accompanied by the deformation of the elastic member, and is not substantially transmitted to the vehicle body 4.

On the other hand, as shown in FIG. 4B, when the angle θ is less than 150 degrees, F2 of components along the straight line 60 of the force F1 acting on the connection point P of the trailing arm 40 increases as the angle θ approaches 90 degrees. That is, the amount of input from the road surface transmitted to the vehicle body 4 increases. Note that, in FIGS. 4A and 4B shown in the drawings, the case where the force F1 directed upward is applied to the connection point P by the reaction torque based on the unevenness of the road surface has been described, but similarly, in the case where the force F1 directed downward is applied to the connection point P, by setting the angle θ to 150 degrees or more and 210 degrees or less, it is possible to reduce the amount of transmission of the vehicle body 4 input from the road surface.

Since the trailing arm 40 is connected to the vehicle body 4 via the bushing 48 at the connection point Z, such vertical vibration or the like is less likely to be transmitted to the vehicle body 4.

Although only one motor unit 20 included in one wheel has been described in the above embodiment, the vehicle 2 may include such a motor unit 20 in a plurality of wheels 6, for example, a plurality of rear wheels 6.

In the above embodiment, the bushings 44 and 48 are exemplified as an example of the elastic member, but the present disclosure is not limited thereto, and other members exhibiting the same action can be appropriately selected and used by those skilled in the art.

In view of the foregoing, the present specification includes the following configurations.

[1] A vehicle includes:
a vehicle body;
a wheel supporting the vehicle body;
a motor unit including an in-wheel motor for driving the wheel; and
a trailing arm connected to the motor unit via an elastic member and extending toward the vehicle front.
A vehicle, wherein an angle θ formed by a first straight line connecting a wheel rotation center coinciding with a rotation axis of the wheel and a first connection point which is a connection point between the motor unit and the trailing arm, and a second straight line connecting the first connection point and a second connection point which is a connection point between the trailing arm and the vehicle body is 150 degrees or more and 210 degrees or less.
[2] The vehicle according to [1], wherein the angle is 160 degrees or more and 200 degrees or less.
[3] The vehicle according to [1] or [2], wherein the angle is 170 degrees or more and 190 degrees or less.
[4] The vehicle according to any one of [1] to [3], wherein the motor unit further includes a speed reduction mechanism.
[5] The vehicle according to any one of [1] to [4], wherein the trailing arm is connected to the vehicle body via an elastic member.

Although the specific examples disclosed by the present disclosure have been described in detail above, these are merely examples and do not limit the scope of claims. The techniques described in the claims include various modifications and alterations of the specific examples illustrated above. The technical elements described in this specification or in the drawings may be used alone or in various combinations, and are not limited to the combinations described in the claims at the time of filing. The technology illustrated in the present specification or the drawings can achieve a plurality of objects at the same time, and has technical usefulness in achieving one of the objects.

What is claimed is:

1. A vehicle comprising:
a vehicle body;
a wheel supporting the vehicle body, a motor unit including an in-wheel motor that drives the wheel; and
a trailing arm linked to the motor unit through an elastic member and extending toward a vehicle front, wherein an angle made by a first straight line connecting a wheel rotation center that matches a rotation axis of the wheel and a first linking point that is a linking point of the motor unit and the trailing arm, and a second straight line connecting the first linking point and a second linking point that is a linking point of the trailing arm and the vehicle body, is no less than 150 degrees and no more than 210 degrees.

2. The vehicle according to claim 1, wherein the angle is no less than 160 degrees and no more than 200 degrees.

3. The vehicle according to claim 2, wherein the angle is no less than 170 degrees and no more than 190 degrees.

4. The vehicle according to claim 3, wherein the motor unit further includes a speed reduction mechanism.

5. The vehicle according to claim 1, wherein the trailing arm is linked to the vehicle body through an elastic member.
